(19) United States
(12) Patent Application Publication
(10) Pub. No.: US 2005/0269866 A1
(43) Pub. Date: Dec. 8, 2005

(54) Multi-piece wheel assembly with transparent components

(76) Inventor: Doug McGoon IV, Pomona, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/145,014

(22) Filed: Jun. 3, 2005

Related U.S. Application Data
(60) Provisional application No. 60/577,346, filed on Jun. 3, 2004.

(51) Int. Cl. B60B 3/10

(52) U.S. Cl. 301/64.701; 301/63.101

(57) ABSTRACT

Wheel assemblies for motor vehicles that include structural components made from at least partially transparent materials. The wheels include a metallic outer rim configured for mounting conventional tires. The outer rim is joined to a centrally arranged structural component which is at least partly transparent. The center component can be made from hi9gh strength polycarbonate material. The outer rim can be of multi-piece or single piece construction. Mounting adapters can be attached to the wheel assemblies. The mounting adapters can be provided in varying thicknesses and mounting hole patterns to allow the wheels to fit a variety of different vehicle configurations. The wheels can include mounting assemblies including wheel bearings and brake rotor mounts to allow the wheel to be fitted to motorcycles.

### CROSS-REFERENCE TO RELATED APPLICATIONS

This application claims the benefit of U.S. provisional application 60/577,346 filed Jun. 3, 2004 entitled “MULTI-PIECE WHEEL WITH NON-METALLIC COMPONENTS” which is incorporated herein in its entirety by reference.

### BACKGROUND OF THE INVENTION

1. Field of the Invention

The invention relates to the field of original equipment or aftermarket wheels for motor vehicles and, more particularly, to wheels which include at least partially transparent components.

2. Description of the Related Art

A wide variety of wheel configurations are known from both original equipment manufacturers and after market sources for passenger cars and trucks, commercial vehicles, motorcycles, and the like. There is a large and widely varied market for wheels coming either from an original equipment manufacturer or purchased as after market accessories to provide a vehicle with enhanced aesthetic characteristics. For example, consumers may purchase wheels having decorative covers, chrome finishings, wheel spinners, and/or modified spoke or hole patterns to provide a desired aesthetic appearance to the vehicle so provided.

Consumers also desire wheels provided either by the original manufacturer or as after market accessories that improve the performance of the vehicle. For example, consumers may desire wheels which are wider or larger in diameter to which lower profile tires may be fitted to provide improved handling response. Consumers also desire wheels which are of reduced weight to provide the vehicle with the significant advantage of reduced unsprung weight to improve handling response. Lower unsprung weight also improves ride comfort due to the reduced influence upon the vehicle of oscillatory inertial loads of the wheel and tire in contact with an uneven road surface.

Metal materials are typically employed for wheels due to their preferable material characteristics of ductility, fatigue resistance, resistance to absorption or loss of water, resistance to corrosion or other material degradation over time when properly treated or coated, and the ability to be machined or forged into desired shapes. However, metal as a material for wheels also has some inherent limitations for certain aesthetic features. For example, metal material is not able to conduct light being opaque and is thus limited to reflective optical effects for its aesthetic presentation. Metal is also relatively dense compared to other materials and thus metal-based wheels are generally heavier than comparably sized components made of alternative materials.

Thus, it will be appreciated that there is an unsatisfied need for wheel configurations offering aesthetic and weight advantages over solely metal-based wheel configurations. There is also an unsatisfied need for wheel designs which admit of optical effects which are not limited strictly to the reflective properties of the materials.

### SUMMARY OF THE INVENTION

The aforementioned needs are satisfied by the invention which in one aspect is a multi-piece wheel assembly which includes structural components made of non-metallic materials. In one embodiment, the multi-piece wheel assembly comprises a metallic outer hoop to which a tire is fitted and a central, generally disk-shaped portion which is formed out a material which has a relatively large optical transmissibility. In one particular embodiment, the outer hoop comprises aluminum or magnesium alloy and the generally disk-shaped central portion is made of polycarbonate such that the central portion of the wheel assembly is substantially transparent.

In other embodiments, the central disk-shaped portion comprises a material which is substantially transparent however upon at least one surface of which the material is roughened or frosted to provide a more visibly apparent surface to the wheel. In other embodiments, at least one surface of the central disk portion is provided with a coating or finish, such as paint, powder coating, or chroming with the remainder of the material being substantially transparent such that the wheel assembly has both reflective and light-transmissive portions.

In certain embodiments, the wheel assembly is of a modular construction such that the central portion may be attached to a wide variety of outer hoops provided by different manufacturers or sources. In certain embodiments, the wheel assembly also comprises a mounting adapter which can be configured for a wide variety of different bolt patterns and wheel offset to allow the wheel assembly to be fitted to a wide variety of vehicles.

The multi-piece wheel assembly comprising non-metallic components is significantly lighter than known wheel configurations as well as offering significant strength and toughness advantages. In particular embodiments wherein the central portion comprises polycarbonate, the material is resistant to high temperatures far in excess of what would typically be encountered in normal vehicle environments as well as being of high strength to resist bending, cracking, breaking, or fatigue from repeated stress.

Thus, one embodiment comprises a motor vehicle comprising one or more wheel assemblies wherein the wheel assemblies comprise a centrally arranged, planar structural component wherein structural support properties of the centrally arranged component are substantially provided by at least partially transparent materials.

Another embodiment comprises a wheel for motor vehicles comprising an annular outer rim portion configured for fitting of a tire at an outer contour thereof and defining an inner circumference and a planar central portion attached to the inner circumference wherein the central portion comprises at least partially transparent structural material. These and other objects and advantages of the invention will be more apparent from the following description taken in conjunction with the accompanying drawings.

### BRIEF DESCRIPTION OF THE DRAWINGS

FIG. 1 is a perspective view of one embodiment of an at least partially transparent wheel assembly;

FIG. 2 is a front or top view of the embodiment shown in FIG. 1;

FIG. 3 is an end or side-section view of one embodiment of a multi-piece wheel assembly with transparent components;

FIG. 4 is an end or side-section view of another embodiment of a multi-piece wheel assembly with transparent components;

FIG. 5 is an end or side section view of one embodiment of an illuminated transparent wheel;

FIG. 6 is an end or side section view of one embodiment of an illuminated transparent wheel;

FIG. 7 is an end or side section view of one embodiment of an illuminated transparent wheel;

FIG. 8 is a front or top view of one embodiment of a transparent wheel with applied graphics;

FIG. 9 is a perspective view of another embodiment of a transparent wheel assembly adapted for motorcycles;

FIG. 10 is a cross-section view of the embodiment illustrated in FIG. 9; and

FIGS. 11 and 12 illustrate in perspective and side disassembled views respectively another embodiment of a wheel having transparent structural components.

### DETAILED DESCRIPTION OF THE PREFERRED EMBODIMENT

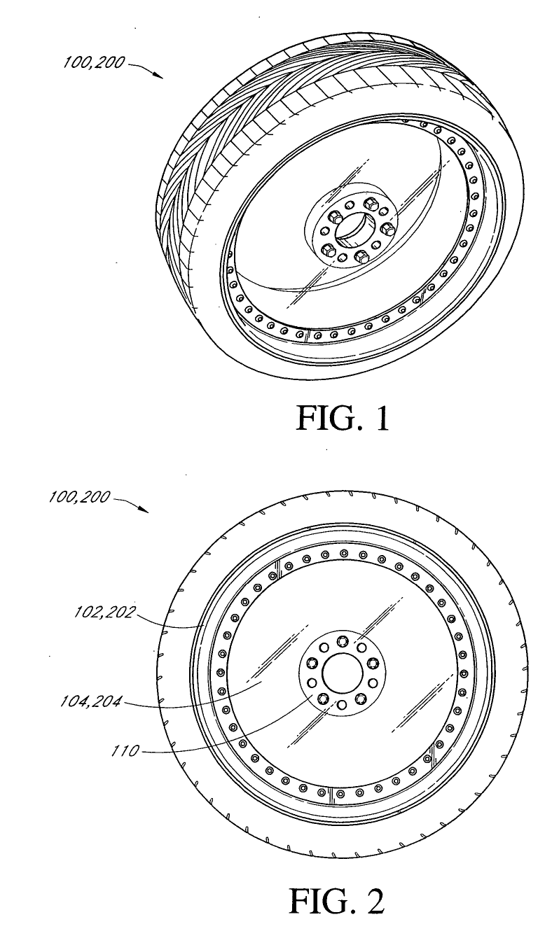

FIGS. 1 and 2 illustrate in perspective and front view respectively, embodiments of a multi-piece wheel assembly 100, 200. The wheel assembly 100, 200 is adapted for fitment of a conventional tire for use on personal automobiles such as cars, trucks, and motorcycles. The wheel assembly 100, 200 can be provided in a variety of wheel diameter in which to suit the requirements of particular applications. The unique construction and materials of the wheel assemblies 100, 200 also offer weight saving performance advantages as well as innovative aesthetic properties as will be described in greater detail below.

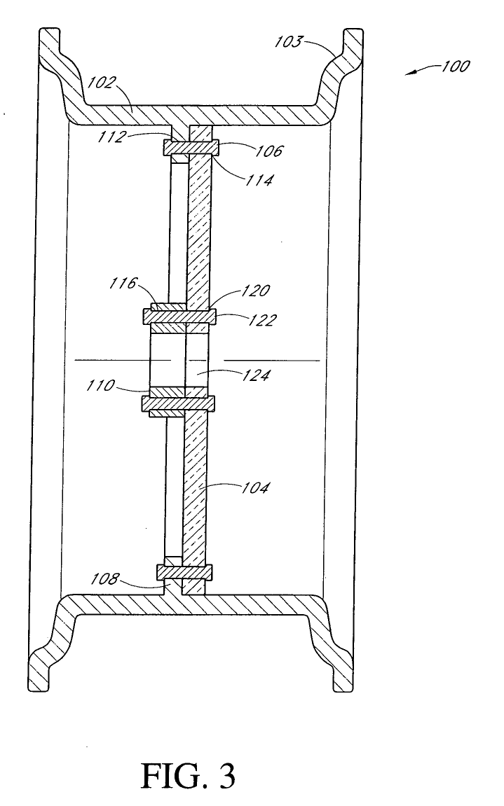

The wheel assembly 100, 200 comprises a generally annular rim portion 102, 202 of circular cross-section. In certain embodiments, the rim portion 102 is of a one piece construction and in other embodiments, the rim portion 202 comprises multiple pieces which are joined together to form the rim portion 202. The rim portions 102, 202 preferably comprise a metal alloy, such as an aluminum, steel, and/or magnesium alloy to provide strength, toughness, ductility, and machinability. The rim portions 102, 202 are configured for mounting of conventional tires and thus define outer contours 103, 203 (FIG. 3) adapted to match industry standard shapes and sizes for mounting of tires which can be either tubeless or inner tubed tires. The rim portions 102, 202 are also suitable for the full variety of known surface finishes including a polished or brushed finish, clear coating, anodizing, painting, chroming or other plating processes, and the like.

The wheel assembly 100, 200 also comprise an at least partially transparent central portion arranged inside the inner circumference of the rim portion 102, 202. The central portion 104, 204 comprises a generally planar circular member which is arranged within the inner circumference of the rim portion 102, 202 and approximately centrally located axially therein. The central portion 104, 204 comprises a relatively high strength and optically transparent plastic material and in certain preferred embodiments, comprises polycarbonate. Polycarbonate is also commonly known under the trademark name, Lexan. Depending upon the requirements of particular applications, certain embodiments comprise polycarbonate which is processed for improved mechanical and/or machining properties with partially degraded optical characteristics. In other embodiments, the central portion 104, 204 comprises polycarbonate having enhanced optical clarity with slightly reduced mechanical properties. In certain embodiments, the polycarbonate can be reinforced with glass or other reinforcing fibers.

Depending upon the strength and size requirements of a particular wheel assembly 100, 200 for a given application, the thickness of the central portion 104, 204 can range from fractions of an inch up to approximately 2 inches. In certain embodiments, the material properties of the central portion 104, 204 comprising one or more types of polycarbonate, provide particular material and functional advantages as compared to conventional materials utilized for wheels. For example, in certain embodiments, the central portions 104, 204 comprising polycarbonate, have a density of between 1.2 and 1.4 g/cm³. As a comparison, conventional materials such as magnesium, aluminum, and steel alloys have densities ranging from approximately 1.8 to 7.9 g/cm³. Thus, embodiments of the central portion 104, 204 have significantly lower density than conventional materials offering significant weight savings for embodiments of the wheel assembly 100, 200. Embodiments of the central portion 104, 204 comprising polycarbonate have a useful working temperature range of approximately −40° C. to 240° C. which encompasses operating conditions for common personal automobiles or other motor vehicles. An additional advantage of embodiments of central portion 104, 204 comprising polycarbonate are electrically insulating characteristics as polycarbonates has a dielectric strength of approximately 400 V/mil or a volume resistivity of approximately 10¹⁶ Ω-cm.

In certain embodiments, the central portion 104, 204 is generally planar presenting a smooth, flat surface. This contributes to unique optical characteristics of the wheel assemblies 100, 200 which will be described in greater detail below and which are not readily feasible with strictly metallic based wheels. The central portion 104, 204 is also materially continuous in a circumferential extend while retaining optical transparency. For example, in certain embodiments, the central portions 104, 204 lack spoke or reinforcing rib arrangements but rather have a substantially uniform thickness circumferentially at a given radial distance from the center and are materially and thus structurally continuous. Known wheels may have gaps between spokes or various voids between ribs or structural members through which light can pass, but with material discontinuities or absences which do not contribute to the structural strength of those wheels.

The rim portion 102, 202 is attached to the central portion 104, 204 in a variety of embodiments. For example, in one embodiment as illustrated in FIG. 3, the rim portion 102 defines a mounting flange 108 extending radially inward from an inner circumference of the rim portion 102. The mounting flange 108 comprises a plurality of openings 112 extending generally axially with respect to the rim portion 102. The central portion 104 comprises correspondingly positioned openings 114 such that a plurality of connectors 106 can be positioned within the openings 112, 114 to join and interconnect the rim portion 102 to the central portion 104. In various embodiments, the connectors 106 can comprise threaded connectors, rivets, expanding members, or the like to fixedly attach the rim portion 102 to the central portion 104.

In this embodiment, the wheel assembly 100 also comprises a mounting adaptor 110 which is configured to facilitate mounting the wheel assembly 100 to a motor vehicle. In one particular embodiment, the mounting adaptor 110 comprises a generally planar circular member and is formed of metal, phenolic, plastic, or other relatively high strength machinable material. In this embodiment, the mounting adaptor 110 also comprises a centrally positioned mounting opening 124 which is configured to receive a central spindle shaft of the vehicle such that the wheel assembly 100 can be secured to the vehicle via a spin-on fastener of conventional type or any other type of known attachment device.

The mounting adaptor 110 also comprises a plurality of openings 116 which are aligned with corresponding openings 120 in the central portion 104. A corresponding plurality of connectors 122 can thus be applied to attach the mounting adaptor 110 to the central portion 104 and thus to the wheel assembly 100. In this embodiment, various configurations of the mounting adaptor 110 can be attached to the central portion 104 of the wheel assembly 100 to enable the wheel assembly 100 to be attached to a variety of configurations of individual motor vehicles. This provides additional flexibility for the utilization of the wheel assembly 100 as different mounting adaptors 110 can be used to allow the wheel assemblies 100 to be fitted to a variety of different vehicles.

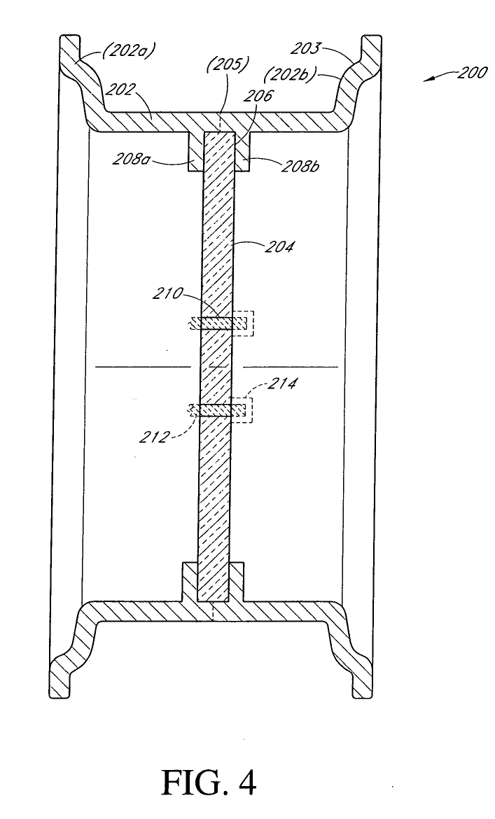

FIG. 4 illustrates in cross-section view another embodiment of wheel assembly 200. In this embodiment, a rim portion 202 is also attached to at least partially transparent central portion 204 to form the wheel assembly 200. In this embodiment, the rim portion 202 defines a pair of opposed mounting flanges 208A and 208B which are attached to the central portion 204 by a friction fit 206. In a first embodiment of the wheel assembly 200, a pair of first and second rim portions indicated parenthetically as 202A and 202B, are joined at a joint 205 to form the rim portion 202. In this embodiment, the joint 205 can comprise a friction or heat weld, an adhesive joint or other method of joining material components as well understood.

In a second embodiment of the wheel assembly 200, the rim portion 202 also comprises a pair of opposed mounting flanges 208A and 208B, however, is of a one piece configuration. In this embodiment, the rim portion 202 is partially expanded or splayed open to a C shape to provide clearance for insertion of the central portion 204 within the opposed mounting flanges 208A and 208B. The rim portion 202 is then closed such that opposed ends of the rim portion 202 are brought into adjacency. The joint 205 is formed to seal the rim portion 202 to form a closed annular structure and so as to form the friction fit 206 between the rim portion 202 and the central portion 204.

In these embodiments, the wheel assembly 200 comprises a plurality of mounting openings 210 which are arranged in a circular pattern of a centerline of the wheel assembly 200. The mounting openings 210 are also formed in a pattern to mate with corresponding wheel studs 212 of the vehicle such that the wheel assembly 200 can be attached to the vehicle by a corresponding plurality of lug nuts 214 which are secured to the ends of the wheel studs 212.

Thus, in these embodiments, the joint 205 can comprise a circumferentially extending joint between multiple rim portions 202A and 202B which are joined at the joint 205 to form the rim portion 202 and in yet other embodiments, the joint 205 is an axially extending joining of opposed ends of a one piece rim portion 202.

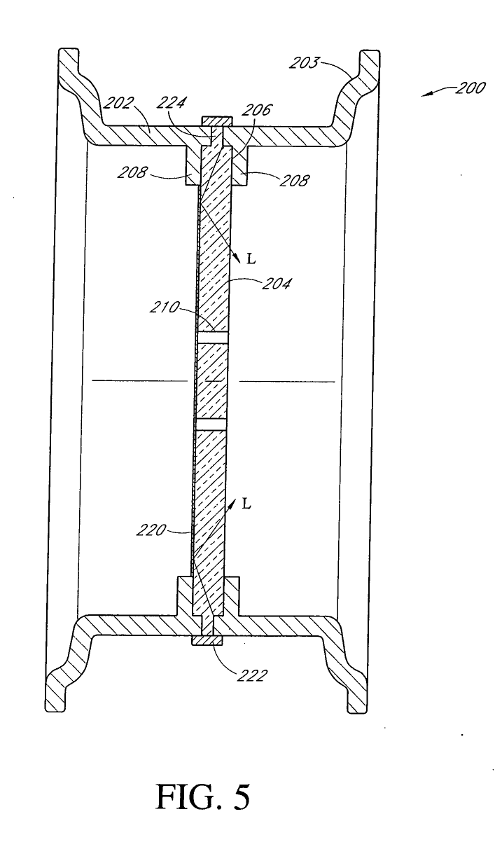

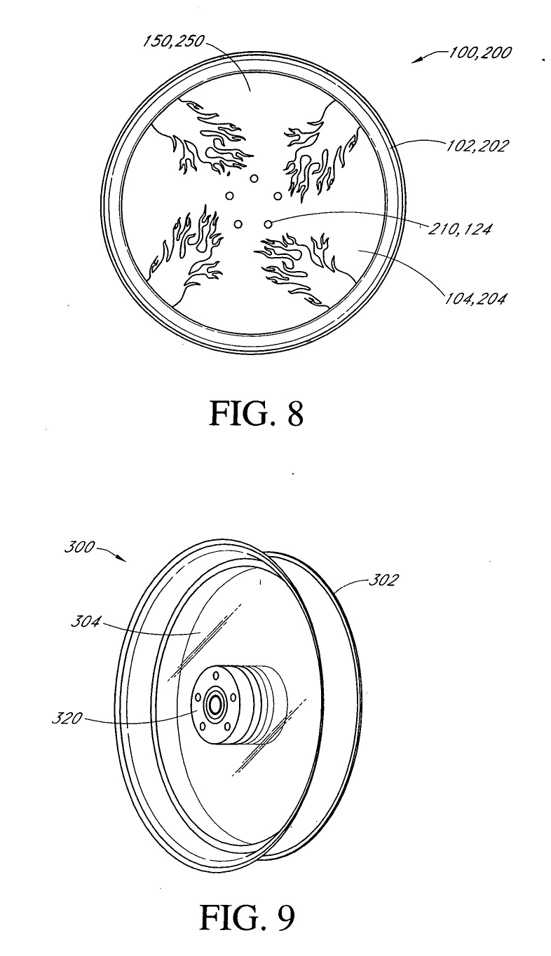

FIGS. 5-8 illustrate several embodiments of improved aesthetic characteristics of the wheel assemblies 100, 200. FIG. 5 illustrates one embodiment in which an opaque finish 220 is applied to an internal or proximal surface of the central portion 204. As previously described, the central portion 204 comprises a substantially transparent material which in certain embodiments comprises polycarbonate. The opaque finish 220 provides an opaque surface against which light which passes through or within the central portion 204 can be at least partially reflected. In certain embodiments, the opaque finish 220 comprises a highly reflective mirror coating, for example, comprising chromium, aluminum or other highly reflective coatings. In these embodiments, the opaque finish 220 provides a mirror-like effect as the central portion 204 comprises a substantially planar surface to which the opaque finish 220 is applied. In other embodiments, the opaque finish 220 can be embodied as a colored background or can provide a desired graphic 150, 250 as shown in FIG. 8. In other embodiments, the opaque finish 220 comprises a roughed or etched surface finish of the central portion 204.

In certain embodiments, the wheel assemblies 100, 200 can also comprise one or more light sources 222. In the embodiment illustrated in FIG. 5, a plurality of light sources 222 are affixed on the outer contour 203 of the rim portion 202 and further arranged to generate and direct light inward radially along the central portion 204. The light sources 222 provide active sources of light to illuminate the interior of the at least partially transparent central portion 204. In certain embodiments, the light sources 222 are self-powered, such as by batteries forming part of the light sources 222. In other embodiments, the light sources 222 receive power from the vehicle's electrical system.

The light will also be at least partially reflected off of the opaque finish 220 and out of the central portion 204 as indicated by the designation L. Thus, the light sources 222 can provide novel optical or aesthetic characteristics to the wheel assemblies 100, 200 particularly in low light conditions which are not achievable with conventional wheel assemblies comprising strictly opaque components. In this embodiment, the light from the light sources 222 is conducted to a central portion 204 via corresponding light openings 224 formed in the rim portion 202. The light sources 222 and corresponding light openings 224 are preferably formed symmetrically about the circumference of the wheel assembly 200 for improved rotational balance characteristics of the wheel assembly 100, 200.

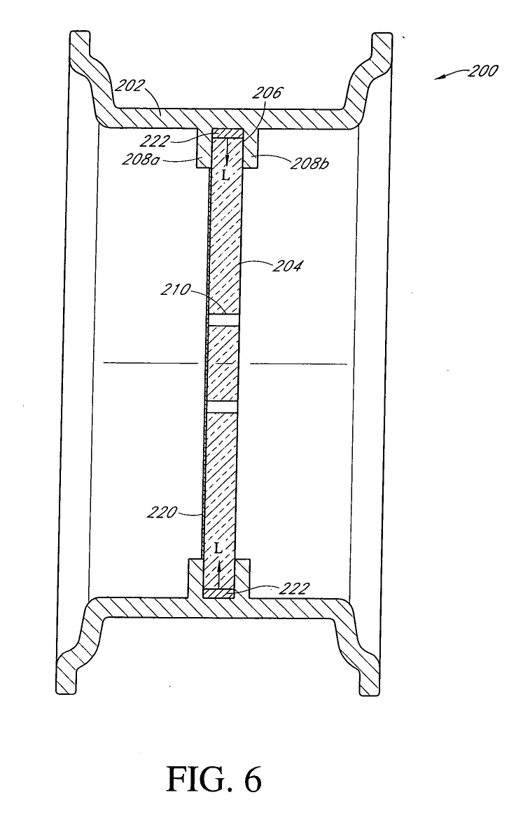

FIG. 6 illustrates another embodiment also comprising an opaque finish 220 and wherein the light sources 222 are interposed between the rim portion 202 and the central portion 204. More particularly, the one or more light sources 222 are positioned at an outer circumference or peripheral edge of the central portion 204 and between the opposed mounting flanges 208A and 208B. The light sources 222 are also arranged to direct the light L inward radially towards the center of the central portion 204. In this embodiment, as the light L need not pass through the rim portion 202, the light openings 224 of the embodiment illustrated in FIG. 5 are omitted.

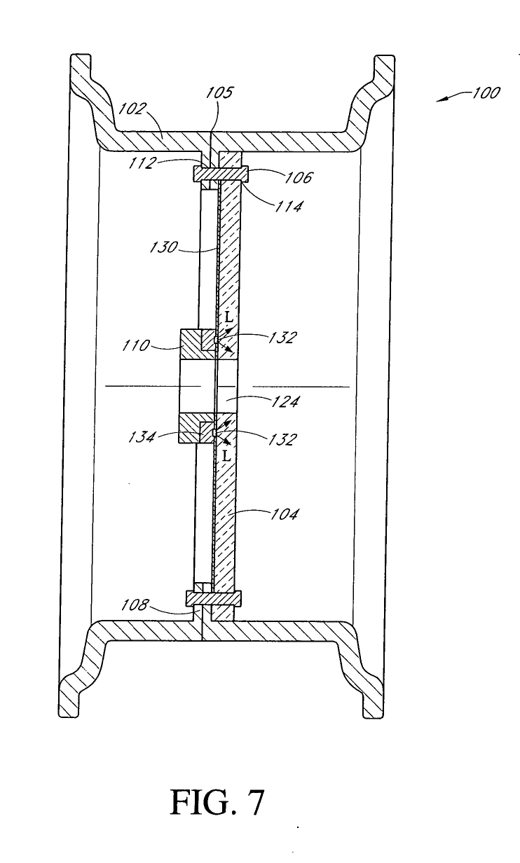

FIG. 7 illustrates yet another embodiment wherein one or more light sources 134 are positioned within or attached to the mounting adaptor 110 to generate and direct light through one or more corresponding light openings 132 in an opaque coating 130. In this embodiment, as the one or more light sources 132 are positioned adjacent the center of the central portion 104 and the wheel assembly 100, the light L will pass generally radially outwards or towards the rim portion 102. In this embodiment, the mounting adapter 110 is attached to the central portion 104 via adhesives.

FIG. 8 illustrates in front or top view that graphics 150, 250 may be applied as part of the opaque coating 130, 220 to present a variety of optical effects to a viewer of the wheel assemblies 100, 200. As a variety of paints, platings, appliqués, and the like maybe applied to the central portion 104, 204, the graphics 150, 250 can present graphic images, text, logos, or the like. Further, as the central portion 104, 204 comprises a relatively large planar surface, a variety of graphics 150, 250 can be embodied which are not readily achievable with conventional wheel structures.

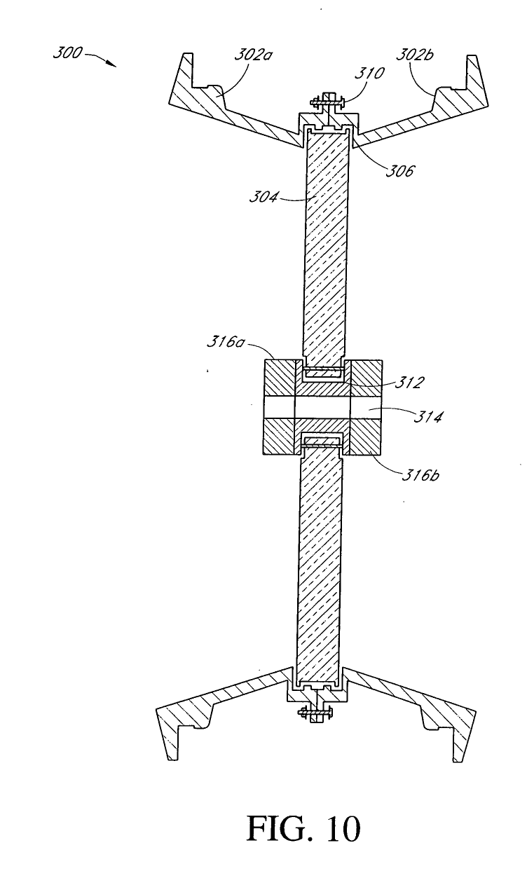

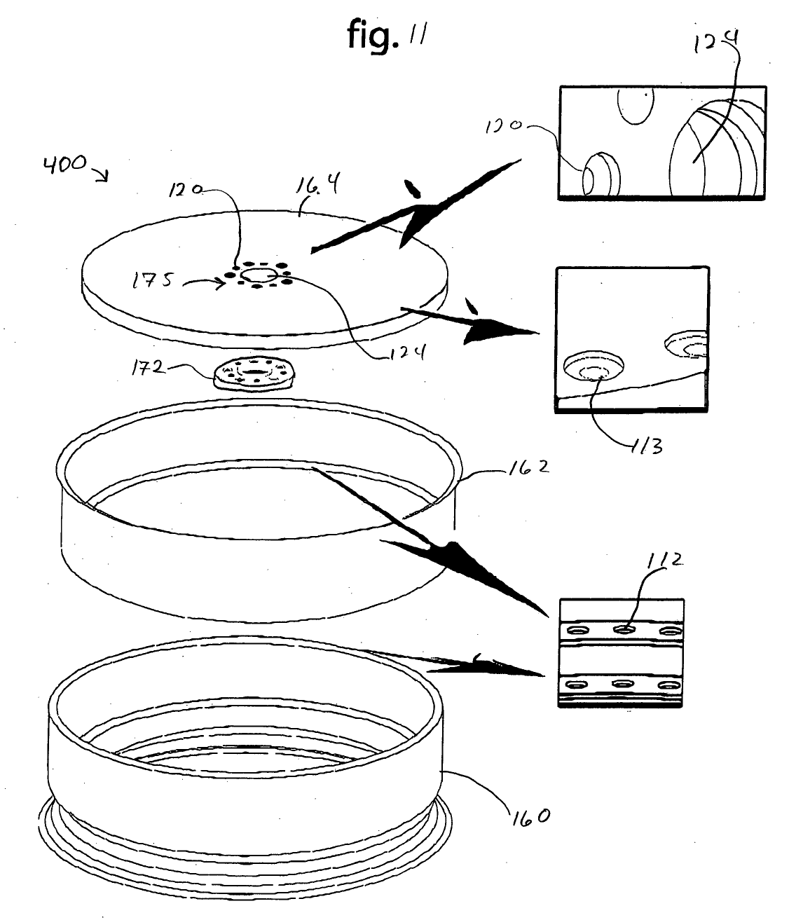

FIGS. 9 and 10 illustrate yet another embodiment of a multi-piece wheel assembly 300 having at least some transparent components. In this embodiment, the wheel assembly 300 is configured for use as a motorcycle wheel. In this embodiment, the wheel assembly 300 comprises a pair of rim portions 302A and 302B which are joined to form the rim portion 302 for mounting of a conventional motorcycle tire. In this embodiment, the rim portions 302A and 302B are substantially duplicate or mirror image similar components which are faced together and joined by a plurality of connectors 310. In this embodiment, the connectors 310 comprise threaded fasteners, however, in other embodiments, the connectors 310 comprise rivets, clinches, friction welds, heat welds, ultrasonic welds, adhesives, or other configurations of connectors 310 for joining into material components.

The rim portions 302A and 302B also together define a receiving area 306 configured to receive a peripheral or circumferential edge of a transparent central wheel portion 304. It will be appreciated that any of a number of different ways of attaching the central portion 304 to the rim 302 can be used without departing from the spirit of the present invention including attaching the flange of FIG. 1 and 2 to the rim 302 and bolting the flange to the central portion 304. The central portion 304 is otherwise similar to the embodiments of central portion 104 and 204 previously described and further adapted to the mechanical and dimensional requirements for the particular application of the wheel assembly 300 for use on a particular motorcycle model.

In this embodiment, the wheel assembly 300 further comprises one or more wheel bearings 312 which are attached to a central portion of the transparent central portion 304. The one or more wheel bearings 312 are configured to receive and be supported by a wheel axle or the motorcycle such that the wheel assembly 300 can freely rotate about the wheel axle yet is restrained against axial movement with respect thereto. In this embodiment, the wheel assembly 300 also comprises one or more brake rotor mounts 316 which are positioned on either or both sides of the wheel bearings 312. Together, the wheel bearings 312 and one or more brake rotors 316 together define a mounting assembly 320 having a mounting opening 314 through which the wheel axle of the motorcycle can pass to mount the wheel assembly 300 to the vehicle.

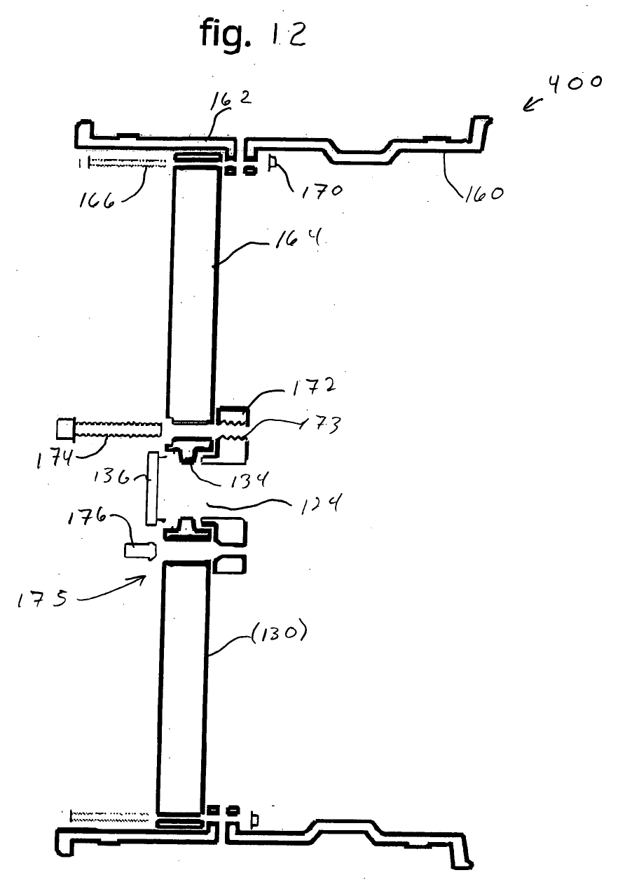

FIGS. 11 and 12 illustrated in perspective and side views respectively a disassembled embodiment of a wheel assembly 400 having transparent structural components. In this embodiment, the wheel assembly 400 comprises an inner hoop 160 and outer hoop 162. The inner and outer hoops 160, 162 are configured for mounting of conventional tubeless or tubed tires. The wheel assembly 400 also comprises a transparent structural member 164. In one embodiment, the inner and outer hoop 160, 162 comprise magnesium alloy and the transparent structural member 164 comprises polycarbonate.

A plurality of openings 112 are formed in the inner and outer hoops 160, 162 which are aligned with corresponding openings 113 in the transparent structural member. A corresponding plurality of outer bolts 166 and mating outer nuts 170 are passed through the openings 112 and 133 and threaded together to interconnect the inner hoop 160, the outer hoop 162, and the transparent structural member 164.

The wheel assembly 400 also comprises a hub plate 172. The hub plate 172 is configured to mate with a motor vehicle. In one embodiment, the hub plate 172 comprises metal or other materials adapted to inhibit heat transfer to the wheel assembly 400. The hub plate 172 is also provided in an appropriate thickness to provide the correct wheel offset for a given application in combination with the applicable vehicle.

The hub plate 172 also comprises a plurality of threaded openings 173 arranged in a generally circular or circumferential pattern. The transparent structural member 164 comprises a corresponding plurality of openings 120 in a central mounting region 175 which are aligned with the threaded openings 173. A plurality of hub plate bolts 174 can then be passed through the openings 120 and threaded into engagement with the threaded openings 173 such that the hub plate 172 is removably attached to the transparent structural member 164. In this embodiment, the wheel assembly 400 also comprises a central opening 124 in the transparent structural member 164. The central opening 124 provides clearance, for example for a wheel bearing grease cap, as well as a mounting opening for trim or decorative components. In certain embodiments, a light source 134 a corresponding battery 136 can be fitted within the central opening 124.

The wheel assembly 400 offers the advantage of modular construction. For example, the hub plate 172 can be removed and replaced with another hub plate 172 having a different thickness to provide an adjustable offset for the wheel assembly 400. One or both of the inner hoop 160 and/or outer hoop 162 can also be detached and replaced with another inner and/or outer hoop 160, 162 to adjust the width of the wheel assembly 400 with out replacing the entire assembly. Similarly, the transparent structural member 164 can also be exchanged for another transparent structural member 164 with, or without, or having a different type of opaque finish 130 to adjust the optical characteristics of the wheel assembly 400 to suit the desired requirements.

As can be seen in the figures, the multi-piece wheel assembly comprises an outer hoop to which the tire mates. The outer hoop can be provided in a wide variety of dimensions both of width and diameter for fitment to tires for use in vehicles ranging from small motor scooters or go-carts up to relatively large commercial vehicles, aircraft, and construction equipment. The outer hoop can be of one or multi-piece construction and in some embodiments comprises aluminum alloy, however in other embodiments comprises magnesium or steel alloys, or other metallic and /or non-metallic materials.

In general, embodiments comprising a single-piece outer hoop which is for example cast or forged, tends to generally be less expensive to manufacture. Embodiments in which the outer hoop is a multi-piece assembly, tends generally to be of lighter weight.

The multi-piece wheel assembly also comprises a generally disk-shaped central portion which is joined to the outer hoop, in this embodiment, in a modular manner via a plurality of fasteners positioned about the periphery of the central portion to fix the central portion to the outer hoop. In these embodiments, the central portion is fastened to the outer hoop via a plurality of fasteners comprising, for example high-strength rivets or threaded fasteners. However, in other embodiments, the central portion can be joined to a separate outer hoop via clenching, adhesives, and/or welding, depending upon the materials used.

In this embodiment, the multi-piece wheel assembly also comprises a mounting adapter which is connected to the central portion and which is configured for attachment of the multi-piece wheel assembly to a particular vehicle. The mounting adaptor can be configured to have a bolt pattern and number to match a given bolt pattern and number of a particular vehicle as well as to have an offset to match the dimensions and indicated suspension requirements of the particular vehicle. In certain embodiments, the mounting adapter is removably attachable to the central portion such that different mounting adapters can be fitted to a given multi-piece wheel assembly to allow the same wheel assembly to be fitted to multiple vehicles. This aspects offers cost savings to a consumer by allowing the consumer to transfer a set of the multi-piece wheels to another vehicle upon purchase, trade, or sale.

In this embodiment, the central portion comprises polycarbonate material of a thickness generally from approximately half an inch to two inches wherein the thickness can be desirably selected to provide appropriate strength characteristics depending on the size and intended usage of the multi-piece wheel assembly while offering significant weight advantages compared to wheels of conventional construction. In this embodiment, the central portion comprises polycarbonate which is substantially transparent and which in this embodiment is provided with a smooth or polished finish on exterior surfaces such that the central portion of the multi-piece wheel assembly is substantially transparent. Thus, in this embodiment, decorative or other lighting may be provided behind the wheel which can readily transmit through the central portion of the wheel assembly for viewing from the outside. In other embodiments, the central portion may be roughened or frosted on one or more sides to provide regions which provide a relatively opaque reflective surface as well as portions which are substantially transparent again such that light may pass through at least a portion of the material of the multi-piece wheel assembly in a relatively unimpeded manner. In other embodiments, one or more sides of the central portion may be provided with a coating, such as paint, powder coating, and/or chroming in a colored or generally colorless manner again to provide optical characteristics for the multi-piece wheel assembly not possible with an all metal construction of strictly opaque material.

In these embodiments, the outer hoop and mounting adapter are provided as separate pieces and comprise metallic material, such as steel, aluminum, magnesium alloys, or other metals with the central portion being provided in a generally transparent, non-metallic material. In these embodiments, the regions of the multi-piece wheel assembly defined by the mounting adapter and outer hoop are mated to portions of the vehicle or other components which are materially opaque. In particular, the mounting adapter attaches to the wheel hub of the vehicle which typically comprises a metallic, ceramic, or carbon-based brake rotor or drum, metallic bearing components, and metallic wheel mounting studs. Similarly, the outer hoop mates to the tire made of opaque rubber, synthetic fibers, steel, and other materials which occlude visibility through the materials. Thus, the mounting adapter and outer hoop do not significantly restrict the otherwise light-transmissive properties of the multi-piece wheel assembly as they are in adjacency with structures or components which are themselves opaque. However, it will be understood that in other embodiments, these portions of the wheel assembly can also be provided in a non-metallic material, such as polycarbonate such that in certain embodiments, substantially all of the wheel assembly comprises non-metallic components. In particular embodiments, the wheel assembly may comprise a substantially single-piece integral wheel assembly comprising non-metallic material, such as the previously described polycarbonate.

It will also be appreciated that while in these embodiments, the central portion of the wheel assembly is substantially and materially continuous, in other embodiments the central portion and/or the outer hoop can be machined, cut, or etched both to remove material for reduced weight as well as to provide a desired aesthetic appearance.

Although the foregoing description of the preferred embodiment of the present invention has shown, described, and pointed out the fundamental novel features of the invention, it will be understood that various omissions, substitutions, and changes in the form of the detail of the apparatus as illustrated, as well as the uses thereof, may be made by those skilled in the art without departing from the spirit of the present invention.

1. A wheel for motor vehicles comprising:
an annular outer rim portion configured for fitting of a tire at an outer contour thereof and defining an inner circumference and
a planar central portion attached to the inner circumference wherein the central portion comprises at least partially transparent structural material.

2. The wheel of claim 1, wherein the outer rim portion is of multi-piece construction.

3. The wheel of claim 1, wherein the outer rim portion comprises two substantially mirror image components which are joined to form the outer rim portion.

4. The wheel of claim 1, wherein the outer rim portion defines at least one mounting flange to which the central portion is attached.

5. The wheel of claim 4, wherein the at least one mounting flange comprises a plurality of openings arranged with a corresponding plurality of openings in the central portion and further comprising a plurality of fasteners interconnecting the outer rim portion and the central portion.

6. The wheel of claim 4, comprising a pair of mounting flanges and wherein the central portion is attached to the outer rim portion via friction fit with the mounting flanges.

7. The wheel of claim 1, wherein the central portion comprises polycarbonate.

8. The wheel of claim 1, wherein at least one surface of the central portion is at least partially provided with an opaque finish.

9. The wheel of claim 8, wherein the opaque finish comprises an opaque coating.

10. The wheel of claim 9, wherein the opaque coating comprises a mirror coating.

11. The wheel of claim 9, wherein the opaque finish comprises a roughed surface of the central portion.

12. The wheel of claim 1, further comprising at least one light source arranged to direct light within transparent regions of the central portion.

13. The wheel of claim 12, wherein the at least one light source is arranged at an outer periphery of the central portion.

14. The wheel of claim 12, further comprising a battery powering the light source.

15. The wheel of claim 1, further comprising a mounting adapter configured to mate with a motor vehicle.

16. The wheel of claim 15, wherein the mounting adapter is removable attached to the central portion such that different mounting adapters can be utilized to enable the wheel to fit a variety of vehicle configurations.

17. The wheel of claim 1, further comprising a mounting assembly configured to mount the wheel to a motorcycle.

18. The wheel of claim 17, wherein the mounting assembly comprises one or more wheel bearings and one or more brake rotor mounts.

19. A motor vehicle comprising one or more wheel assemblies wherein the wheel assemblies comprise a centrally arranged, planar structural component wherein structural support properties of the centrally arranged component are substantially provided by at least partially transparent materials.

20. The motor vehicle of claim 19, wherein inner surfaces of the one or more wheel assemblies are at least partially provided with an opaque finish such that light can pass through an interior and an outer surface of the planar component and such that light is reflected from the opaque finish.

21. The motor vehicle of claim 20, wherein the opaque finish presents a graphic image to an external observer of the motor vehicle.

22. The motor vehicle of claim 19, further comprising light sources arranged to direct light through the centrally arranged structural component.

23. The motor vehicle of claim 19, wherein the vehicle comprises a motorcycle and wherein the one or more wheel assemblies further comprise a mounting assembly configured to mount the wheel assemblies to the motorcycle.

24. A wheel assembly comprising:
a metallic outer hoop configured for mounting of a tire and
a transparent structural member interconnected with the outer hoop wherein the transparent structural member comprises a central mounting region for attachment to a vehicle and wherein the transparent structural member is materially continuous in a circumferential extent between the central mounting region and the outer hoop.
